(19) United States
(12) Patent Application Publication
(10) Pub. No.: US 2005/0090265 A1
(43) Pub. Date: Apr. 28, 2005

(54) Method and apparatus for distributing information in an assisted-SPS system

(76) Inventor: Charles Abraham, Los Gatos, CA (US)

Correspondence Address: Moser, Patterson & Sheridan, LLP, Suite 100, 595 Shrewsbury Avenue, Shrewsbury, NJ, 07702, US

(21) Appl. No.: 10/692,292

(22) Filed: Oct. 23, 2003

(51) Int. Cl. H04Q 7/20

(52) U.S. Cl. 455/456.1; 455/456.6

(57) ABSTRACT

A method and apparatus for distributing information in an assisted-SPS system. The method and apparatus receive information comprising at least one of ionospheric information, clock information, and satellite integrity information from a first satellite in a first satellite network, where the received information pertains to at least one satellite in a second satellite. The received information is combined with assistance data to form augmented assistance data. The augmented assistance data is coupled to a mobile receiver, where the mobile receiver uses the augmented assistance data to process satellite signals from at least one satellite in the second satellite system. Alternatively, the received information can be used by a server to improve the accuracy of a position computation for the mobile receiver.

### BACKGROUND OF THE INVENTION

1. Field of the Invention

The present invention relates to mobile wireless devices as used in personal and asset location systems. In particular, the present invention relates to a method and apparatus for distributing information in an assisted satellite positioning system.

2. Description of the Related Art

Receivers for the Global Positioning System (GPS), GLONASS and GALILEO (all are examples of satellite positioning systems (SPS)) are used to acquire position on ground, in air or in space based upon the reception of SPS constellation. Herein, GPS is used as a specific example of an SPS that may benefit from the invention. Those skilled in the art will understand that the invention is applicable to any assisted-SPS system.

From the GPS satellite transmit antenna, the satellite signals propagate through free space, the ionosphere and the troposphere to a GPS receiver. However, pseudoranges that are computed to determine mobile receiver position are affected by ionospheric propagation delays such that use of the pseudoranges in computing position produce ranging errors.

Ionospheric and tropospheric effects may be significant. The troposphere is the lower part of the atmosphere extending up to an altitude of about 40 km. The propagation delay of the troposphere reaches about 1.9 to 2.5 meters in the zenith direction and increases approximately with the cosecant of the elevation angle. The tropospheric propagation delay is a function of barometric pressure, temperature, humidity, and other weather variables. For many precision GPS applications, the ionospheric error is a substantial source of error as well. As such, the GPS signal contains information regarding a prediction of the ionospheric/tropospheric effects (herein after referred to as “atmospheric effects”). Thus, this information is available for the GPS receiver to adjust code phase delays to compensate for the atmospheric effects.

In some applications of GPS, such as position location of cellular telephones, the signal strength of the GPS satellite signal is so low that either the received signal cannot be processed or the time required to process the signal is excessive. As such, to improve the signal processing, the GPS receiver in the cellular telephone is provided with assistance data. The assistance data may include time and frequency information, pseudorange estimation information, position estimation information, ephemeris information, and the like. Commonly assigned U.S. Pat. No. 6,453,237 issued Sep. 17, 2002 describes the use of assistance data in one embodiment of an assisted-GPS (A-GPS) system and is incorporated by reference herein.

Heretofore, information regarding the atmospheric effect has been decoded from the GPS signal, i.e., the GPS signal carries ionosphere information. As such, the GPS receiver must wait for the GPS signal to be fully decoded to extract the ionosphere information that can then be used to improve the position estimate. Furthermore, the ionosphere information within the satellite signal is not a real-time model of the atmospheric effect. The atmospheric model data is updated only on a periodic basis (e.g., every few days). Generally, the ionosphere information that the satellite signal provides is, at best, a crude estimate of the atmospheric effect.

Thus, there is a need in the art for a method and apparatus that provide a real-time atmospheric model for an assisted-GPS receiver.

### SUMMARY OF THE INVENTION

The present invention is method and apparatus of providing at least one of ionosphere information, clock information or satellite integrity information to a mobile receiver in an assisted-SPS system. In one embodiment, the method receives ionosphere information, clock information and/or satellite integrity information from a first satellite in a first satellite network, where the received information pertains to the satellites in a second satellite network. The received information is combined with conventional assistance data to form augmented assistance data. The augmented assistance data is coupled to a mobile receiver, where the mobile receiver uses the augmented assistance data to acquire and process satellite signals from at least one satellite in the second satellite network.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an architecture for an assisted-GPS (A-GPS) system in accordance with the present invention; and

FIG. 2 depicts a flow diagram representing a method of computing pseudoranges in accordance with the invention.

To facilitate understanding, identical reference numerals have been used, wherever possible, to designate identical elements that are common to the figures.

### DETAILED DESCRIPTION

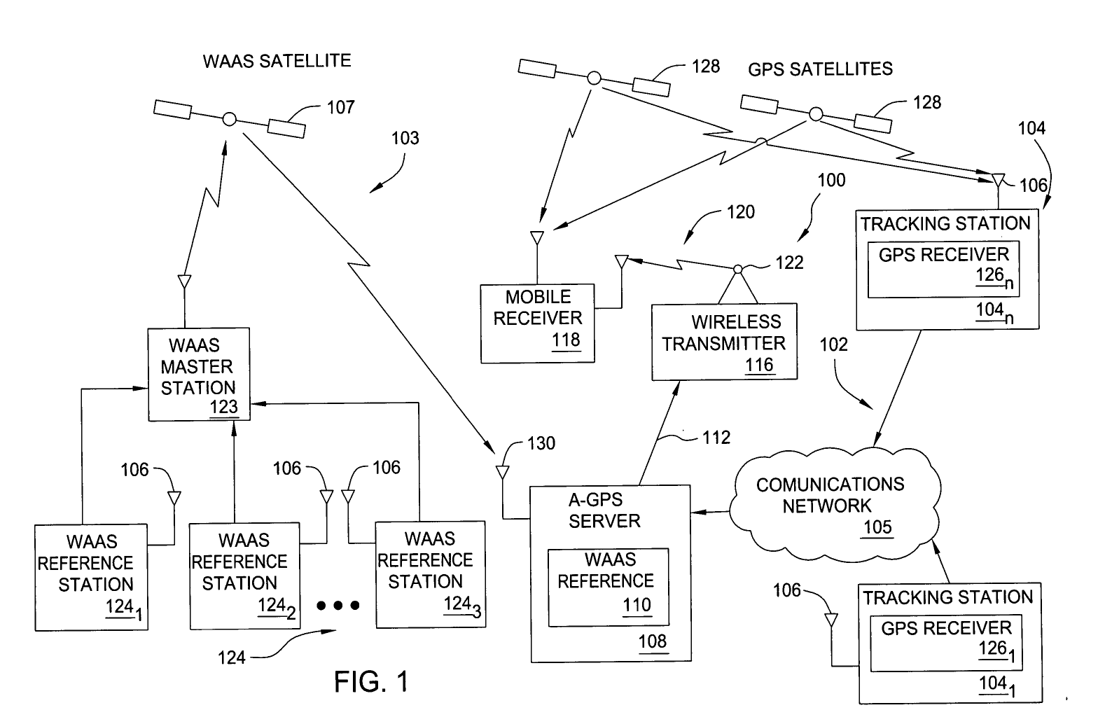

FIG. 1 depicts an architecture for an assisted-GPS (A-GPS) system 100 (one example of an assisted-SPS system) that uses information from the Wide Area Augmentation System (WAAS) 103, in accordance with the present invention. In this embodiment, the WAAS 103 is a first satellite system that provides at least one of ionosphere information, clock information, and satellite integrity information (collectively, the provided information) that pertains to a second satellite network (e.g., a GPS network). The provided information is used to augment conventional assistance data in an assisted-GPS system. The augmented assistance data is transmitted to and used by a mobile device such that the GPS signal reception and processing performance of the mobile device is enhanced by the use of the augmented assistance data.

More specifically, the A-GPS system 100 comprises a reference network 102, an A-GPS server 108, a wireless transceiver 116, and a mobile receiver 118. The reference network 102 comprise a plurality of tracking stations 104₁, 104₂, . . . 104ₙ (collectively tracking stations 104) that are coupled to a communications network 105. The tracking stations receive and process satellite data from a constellation of GPS satellites 128. The communications network 105 is coupled to the A-GPS server 108 to provide satellite tracking data to the A-GPS server 108.

The WAAS 103 comprises at least one satellite 107 in a geostationary orbit, a WAAS master station 123, and a plurality of WAAS reference stations 124₁, 124₂, . . . 124ₙ (collectively WRS 124). The WRS 124 and WMS master station 123 produce and upload to the satellite 107 an ionosphere model, a GPS clock model, and satellite integrity information (collectively referred to herein as the WAAS information). The WAAS information is transmitted by the satellite 107 to a WAAS receiver 110 located in (or coupled to) the A-GPS server 108. As such, the A-GPS server 108 may use some or all of the WAAS information as a portion of the assistance data that the server 108 sends to the mobile receiver 118. Such assistance data is used by the mobile receiver to enhance its capabilities to receive and process GPS signals.

More specifically, the tracking stations 104 are deployed over a wide area and contain GPS receivers 126. The GPS receivers 126 are coupled to antennas 106 that receive GPS signals from the GPS satellites. The receivers 126 process the signals to collect ephemeris from all satellites 128 within a global network of satellites, e.g., the entire GPS constellation. For example, the satellite ephemeris may be received and processed as described in commonly assigned U.S. Pat. No. 6,542,820 issued Apr. 1, 2003 to produce satellite tracking data. This patent is hereby incorporated by reference herein.

The A-GPS server 108 receives the satellite tracking data from the network 102. The A-GPS server 108 generates assistance data that is coupled, as described below, to the mobile receiver 118 to assist the mobile receiver 118 in receiving and processing GPS signals. The A-GPS server 108 comprises a WAAS receiver 110 that provides the WAAS information for inclusion in the assistance data to form augmented assistance data. Alternatively, the WAAS receiver 110 may be located separately from the A-GPS server 108 such as in one or more of the tracking stations 104 or at a stand alone location. The WMS receiver 110 need only provide the WAAS information to the A-GPS server 108. It is not necessary that they WMS receiver and the A-GPS server be geographically near one another.

A communications link 120 allows communication between the A-GPS server 108 and the mobile receiver 118. The mobile receiver 118 contains a GPS receiver that uses the augmented assistance data to improve its GPS signal reception and processing performance. This link 120 to the mobile receiver may have several components, for example: a landline 112 to a wireless transmitter 116 and a wireless link 122 from the transmitter 116 to a mobile receiver 118. In one embodiment of the invention, the mobile receiver 118 is a cellular telephone and the wireless transmitter 116 is a cellular telephone system base station that sends the augmented assistance data to the mobile receiver 118. Other communications paths between the A-GPS server 108 and the mobile receiver 118 may include pager systems, Internet links to a Wi/Fi enabled region, and so on. The requirement of the communication path is that the augmented assistance data be coupled to the mobile device in a continuous, intermittent or periodic manner.

The geostationary WAAS satellite 107 continuously transmits the WAAS information including at least one of a real-time atmospheric model, a GPS clock model, and GPS satellite integrity information. At present, one of the geostationary WAAS satellites serves the Pacific Ocean Region and another geostationary WAAS satellite serves the Atlantic Ocean Region. Note that FIG. 1 depicts one of two geostationary WAAS satellites 107 that orbit the earth.

The WAAS master station (WMS) 123 is used for uploading information to the WAAS satellites 107. WAAS 103 is based on a network of approximately 25 ground reference stations 124 that covers a very large service area. Signals from GPS satellites are received by wide area ground reference stations (WRSs) 124. Each of these precisely surveyed reference stations receive and process GPS signals to calculate position inaccuracies caused by ionospheric disturbances, produce a clock model for each GPS satellite, and identify satellites that are not operating properly (i.e., determine satellite integrity).

These WRSs are linked to the WMS 123 to form the WMS network 103. Each WRS 124 relays WMS information to at least one the WMS 123 where WAAS information is compiled. The WMS 123 compiles a clock model, derives the ionosphere model, and assesses the integrity of the GPS satellites 128. The integrity information allows the mobile receiver 118 to ignore the information from a satellite that is not operating properly (e.g., not transmitting accurate data). The WMS 123 transmits the WAAS information to the WAAS satellite 107.

The WAAS geostationary satellites 107 broadcast signals on the L1 frequency using only a C/A code with a superimposed navigation message. These signals are similar to L1, C/A code broadcast by GPS satellites except that the WAAS signals are modulated with 250 bit-per-second integrity-related information and GNSS satellite range corrections derived from data received from the reference stations. All range corrections are relative to the GPS C/A code only.

The WAAS satellites 107 transmit ionosphere, clock, and satellite integrity information at 1000 bits/sec. The WMS 123 transmits the WAAS information to the satellite 107, which re-transmits the data via a satellite transponder to the WAAS receiver 110.

Since the WAAS model (e.g., the atmospheric model) is updated in real-time by the WMS 123, the A-GPS server 108 receives the WMS information via a WMS antenna 130 and a WMS receiver 110. The A-GPS server 108 uses an estimated position (latitude and longitude) of the mobile receiver 118 in combination with the ionosphere model provided by WAAS 103 to determine the atmospheric effect at the location of the mobile receiver 118. The atmospheric effect is qualified by the ionosphere model as an ionosphere delay value for the satellite transmission. The server 108 converts the ionosphere delay values into a pseudorange correction value and a pseudorange rate correction value. These correction values are distributed by the A-GPS server 108 to the mobile receiver 118 (only one of which is shown for clarity). Additionally, the A-GPS server 108 may optionally use the information received from WAAS 103 regarding the GPS clock model to further adjust the pseudorange correction value and the pseudorange rate correction value. The clock model provides an accurate, real-time model of time errors within the GPS satellites. These time errors affect the pseudorange measurements that are made by the mobile receiver. The correction values are used to correct the pseudorange measurements as described below. The satellite integrity information can be sent to the mobile receiver to provide real-time indication of which satellites are not presently operating properly. These parameters (correction values and satellite integrity) are transmitted as fields in the conventional A-GPS assistance information transmission, see “Position Determination Service Standard for Dual Mode Spread Spectrum Systems”, 3GPP2-C.50022-0-1, 2001 and “Digital Cellular Telecommunications System (phase 2+)” 3GPPTS 04.31 version 8.70 Release 1999 for a description of the assistance information transmission protocols used in the US and Europe. As such, the conventional assistance data is augmented with real-time information regarding at least one of an ionosphere model, clock model, or satellite integrity. Convenient fields to use for this transmission are the differential GPS (DGPS) assistance data fields.

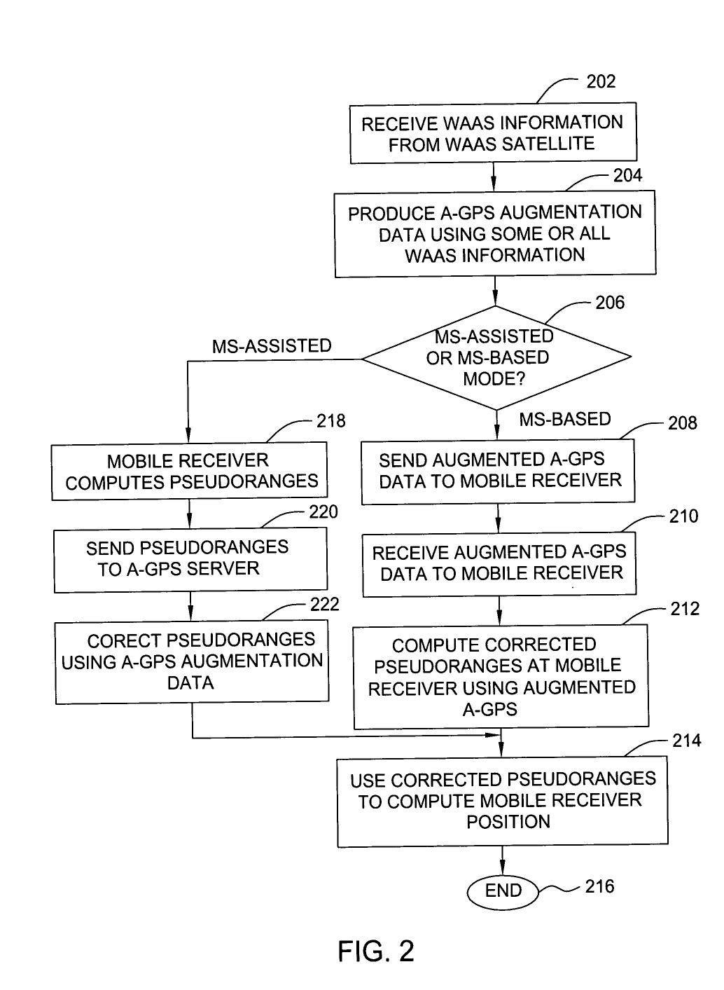

FIG. 2 depicts a flow diagram representing a method 200 of augmenting and distributing A-GPS assistance information in accordance with the invention. At step 202, the A-GPS server 108 receives WAAS information from the WAAS WMS 123 via at least one WAAS satellite 107.

At step 204, the method 200 produces the A-GPS augmentation data using some or all of the WAAS information received from the WAAS satellite 107. Specifically, the A-GPS server 108 augments the conventional assistance data with some or all of the information received from the WAAS 103. For example, ionosphere delay data, clock data and satellite integrity information received from the WMS 103 are used to form the A-GPS augmentation data. This data may include a pseudorange correction value and pseudorange rate correction value that are derived from the ionsphere delay data and/or the clock error. This data also may include the satellite integrity information.

At step 206, the method queries whether the A-GPS system is operating in a mobile receiver assisted mode (referred to as an MS-assisted mode) or a mobile receiver based mode (referred to as a MS-based mode). In MS-assisted mode, the mobile receiver computes pseudoranges to the satellites that are in view. The pseudoranges are sent to the A-GPS server for processing to determine the mobile receiver's position. In MS-based mode, the mobile receiver computes the pseudoranges and uses the pseudoranges locally to determine the mobile receiver's position.

If the system is operating in the MS-based mode, the method 200 proceeds to step 208 where augmented A-GPS data is sent to the mobile receiver. Generally, the augmented A-GPS data comprises the conventional A-GPS data plus the correction values and/or the satellite integrity information. The correction values are, in one embodiment, sent in the DGPS field of the A-GPS data and the satellite integrity information is sent in a “real time integrity” field of the conventional A-GPS data transmission. Alternatively, some or all of the “raw” WAAS information could be sent as augmented A-GPS data to the mobile receiver and the mobile receiver could locally compute the correction values and/or extract the satellite integrity information.

At step 210, the mobile receiver 118 receives the augmented A-GPS data transmitted by the A-GPS server 108.

At step 212, the mobile receiver 118 uses the augmented assistance data to compute and correct the pseudorange estimates for the satellites that are in view of the mobile receiver. Because part of the augmented assistance data comprises pseudorange and pseudorange rate correction values, the mobile receiver 118 is able to compute a more accurate pseudorange estimate. Furthermore, the satellite integrity information can be used to ignore pseudorange values that correspond to inoperative or incorrectly operating satellites. The selective use of pseudoranges is a form of pseudorange correction. It is well-known by those skilled in the art how to use satellite integrity information and/or DGPS correction values to correct pseudorange values. At step 214, the method computes the position of the mobile receiver 118 such that a more accurate pseudorange estimate provides a more accurate position for the mobile receiver 118. The method ends at step 216.

If the system is operating in the MS-assisted mode, the method 200 proceeds from step 206 to step 218. At step 218, the mobile receiver computes pseudoranges in a conventional A-GPS manner, i.e., using ephemeris or a long term orbit model that is sent to the receiver 118 by the server 108. At step 220, the pseudoranges are sent from the mobile receiver 118 to the server 108. At step 222, the A-GPS server 108 uses the A-GPS augmentation data (e.g., the correction values and/or the satellite integrity information) to correct the pseudoranges. It is well known by those skilled in the art how to use satellite integrity information and/or pseudorange and pseudorange rate correction values to correct the pseudoranges provided by the mobile receiver 118. At step 214, the corrected pseudoranges are used by the A-GPS server 108 to compute the mobile receiver's position. The method 200 ends at step 216.

Although the invention is described herein with respect to the use of WAAS to provide more frequently updated GPS satellite and satellite network information, the invention may also be used with similar systems which provide more frequently updated GPS, GLONASS or Galileo satellite information. For example, the invention may be utilized with European Geostationary Navigation Overlay Service (EGNOS) and/or with the Multi-Functional Satellite Augmentation System (MSAS) of Japan. As such, the invention pertains to the use of information provided by a satellite that is not a component of the GPS constellation. Furthermore, GPS is used herein as one exemplary embodiment of a satellite-based system that is used for position location. Other such systems include GLONASS and Galileo.

While the foregoing is directed to embodiments of the present invention, other and further embodiments of the invention may be devised without departing from the basic scope thereof, and the scope thereof is determined by the claims that follow.

1. A method of distributing information to a mobile receiver, comprising;
receiving information representing at least one of ionosphere information, clock information, and satellite integrity information from a first satellite in a first satellite network, where the received information pertains to at least one satellite in a second satellite network;
combining at least a portion of the received information with assistance data to form augmented assistance data; and
coupling the augmented assistance data to a mobile receiver, where the mobile receiver uses the augmented assistance data to process satellite signals from at least one satellite in the second satellite network.

2. The method of claim 1, wherein said first satellite network comprises at least one of a Wide Area Augmentation System (WAAS), Euro Geostationary Navigation Overlay Service (EGNOS) and a Multi-Functional Satellite Augmentation System (MSAS).

3. The method of claim 1, wherein said ionosphere information is ionospheric delay data.

4. The method of claim 1 wherein the second satellite network is part of at least one of a Global Positioning System, GLONASS, and GALILEO.

5. The method of claim 1 further comprising computing, within the mobile receiver, a position of the mobile receiver using the augmented assistance data.

6. The method of claim 1 wherein the augmented assistance data comprises pseudorange correction data that is derived from the received information.

7. The method of claim 6 wherein the pseudorange correction data is sent to the mobile receiver as differential GPS data.

8. A method of generating assistance data for an assisted-SPS system comprising:
receiving information representing at least one of ionosphere information, clock information, and satellite integrity information from a first satellite in a first satellite network, where the received information pertains to at least one satellite in a satellite positioning system (SPS) satellite network;
combining the received information with assistance data to form augmented assistance data that can be used to process satellite signals transmitted by at least one SPS satellite.

9. The method of claim 8, wherein said first satellite network comprises at least one of a Wide Area Augmentation System (WAAS), a Euro Geostationary Navigation Overlay Service (EGNOS) and a Multi-Functional Satellite Augmentation System (MSAS).

10. The method of claim 8, wherein said ionosphere information is ionospheric delay data.

11. The method of claim 11 wherein the SPS is part of at least one of a Global Positioning System, GLONASS and Galileo.

12. The method of claim 8 further comprising computing, within the mobile receiver, a position of the mobile receiver using the augmented assistance data.

13. The method of claim 8 wherein the augmented assistance data comprises pseudorange correction data that is derived from the received information.

14. The method of claim 13 wherein the pseudorange correction data is sent to the mobile receiver as differential GPS data.

15. Apparatus for providing atmospheric information to a mobile receiver comprising:
a receiver adapted to receive information representing at least one of ionosphere information, clock information, and satellite integrity information from a first satellite in a first satellite network, where the received information pertains to at least one satellite in a second satellite network;
a server, coupled to the receiver, for combining at least a portion of the received information with assistance data to form augmented assistance data that can be used by a mobile device to process satellite signals from at least one satellite in the second satellite network.

16. The apparatus of claim 15 further comprising:
a wireless network, coupled to the server, for transmitting the augmented assistance data to a mobile receiver.

17. The apparatus of claim 15 wherein said ionosphere information comprises an ionospheric delay data.

18. The apparatus of claim 15 wherein said first satellite network is at least one of a Wide Area Augmentation System (WAAS), Euro Geostationary Navigation Overlay Service (EGNOS), and Multi-Functional Satellite Augmentation System (MSAS).

19. A method of improving a position computation accurately comprising:
receiving information at an A-GPS server representing at least one of ionosphere information, clock information and satellite integrity information from a first satellite in a first satellite network, where the received information pertains to at least one satellite in a second satellite network;
computing within a mobile receiver at least one pseudorange measurement, where the pseudorange measurement represents a relative distance between a mobile receiver and at least one satellite in the second satellite network;
sending the at least one pseudorange measurement to the A-GPS server;
correcting the at least one pseudorange measurement using the received information; and
computing a position of the mobile receiver using the corrected at least one pseudorange.

20. The method of claim 19, wherein said first satellite network comprises at least one of a Wide Area Augmentation System (WAAS), Euro Geostationary Navigation Overlay Service (EGNOS) and a Multi-Functional Satellite Augmentation System (MSAS).

21. The method of claim 19, wherein said ionosphere information is ionospheric delay data.

22. The method of claim 19 wherein the second satellite network is part of at least one of a Global Positioning System, GLONASS, and GALILEO.
